(19) United States
(12) Patent Application Publication
(10) Pub. No.: US 2010/0225808 A1
(43) Pub. Date: Sep. 9, 2010

(54) Closed-Captioning System and Method

(75) Inventor: Mark Gilmore Mears, Zionsville, IN (US)

Correspondence Address: Robert D. Shedd, Patent Operations;THOMSON Licensing LLC, P.O. Box 5312, Princeton, NJ, 08543-5312, US

(73) Assignee: THOMSON LICENSING, Boulogne-billancourt (FR)

(21) Appl. No.: 12/223,148

(22) PCT Filed: Jan. 27, 2006
(86) PCT No.: PCT/US2006/002942

§ 371 Date: Jul. 23, 2008

(51) Int. Cl. H04N 7/00

(52) U.S. Cl. 348/468; 348/E07.001

(57) ABSTRACT

A method and apparatus for processing closed caption information associated with a video program by identifying a parameter associated with the video program; and, formatting the appearance of the closed caption information in response to the identified parameter. The parameter may comprise genre information, and may be identified from program and system information protocol signals, extended data service information, or program guide data.

### FIELD OF THE INVENTION

This invention relates to receivers having circuitry for receiving and processing closed caption data.

### BACKGROUND OF THE INVENTION

Closed-caption systems aid the hearing-impaired in enjoying video programs (sometime referred to as “programs” or “programming”). In such a system, text corresponding to words spoken, and sometimes other sounds, in a program are transmitted with the picture and sound information from the broadcast transmitter. The closed-caption text, or content, is typically displayed at the bottom of the screen in a manner similar to the way in which motion picture subtitles are displayed so that a hearing-impaired viewer may better understand the television program. Closed caption systems also enable a user to view the spoken contents of a program without disturbing someone else in the vicinity of the television.

In a closed-caption system, closed-caption text is conventionally transmitted a few characters at a time during the vertical blanking interval on television line 21. A closed-caption decoder captures the closed caption content on line 21, and displays it via on-screen display circuitry. In a digital television environment, the closed caption data may be transmitted in designated transport packets multiplexed with the audio and video packets of the associated program. Conventionally, the closed caption text is display in the same manner for all of the programs, and the text associated with the program, on a television display, that is, using a particular font, size, color, etc. It may be desirable to display the closed caption data in different ways to facilitate user understanding and enjoyment of the displayed data.

### SUMMARY OF THE INVENTION

The present invention provides an apparatus and a method for identifying certain parameters associated with a video program, or closed caption information, and modifying the display of the closed caption information, or portions of the closed captions information. According to a first aspect of the present invention, the invention provides a method for processing closed caption information associated with a video program, comprising: identifying a parameter associated with the video program; and, formatting the appearance of the closed caption information in response to the parameter. The parameter may comprise genre information associated with the video program. The parameter may be derived from an associated program and system information protocol signal, extended data services information, or program guide information.

According to a second aspect of the present invention, an apparatus including: a memory storing data indicative of a plurality of formats each corresponding to an associated condition; a receiver for receiving a video program and associated closed caption content; a detector for detecting a parameter associated with the video program; and a processor for formatting the appearance of at least a portion of the received closed caption content in response to the detector detecting the parameter. In a further embodiment, the invention provides an interface for allowing a user to selectively enable or disable the formatting the appearance of the at least a portion of the received closed caption content.

### BRIEF DESCRIPTION OF THE FIGURES

Understanding of the present invention will be facilitated by consideration of the following detailed description of the preferred embodiments of the present invention taken in conjunction with the accompanying drawings, wherein like numerals refer to like parts and:

FIG. 1 illustrates a block diagram of a television receiver;

FIG. 2 illustrates a flow diagram of a process according to a aspect of the present invention; and

FIG. 3 illustrates a flow diagram of a process according to a second aspect of the present invention;

FIG. 4 illustrates a flow diagram of a process according to a third aspect of the present invention; and

FIG. 5 illustrates a flow diagram of a process according to a fourth aspect of the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for purposes of clarity, many other elements found in typical television programming, broadcast, reception and presentation systems. Those of ordinary skill in the art will recognize that other elements are desirable and/or required in order to implement the present invention. However, because such elements are well known in the art, a detailed discussion of such elements is not provided herein.

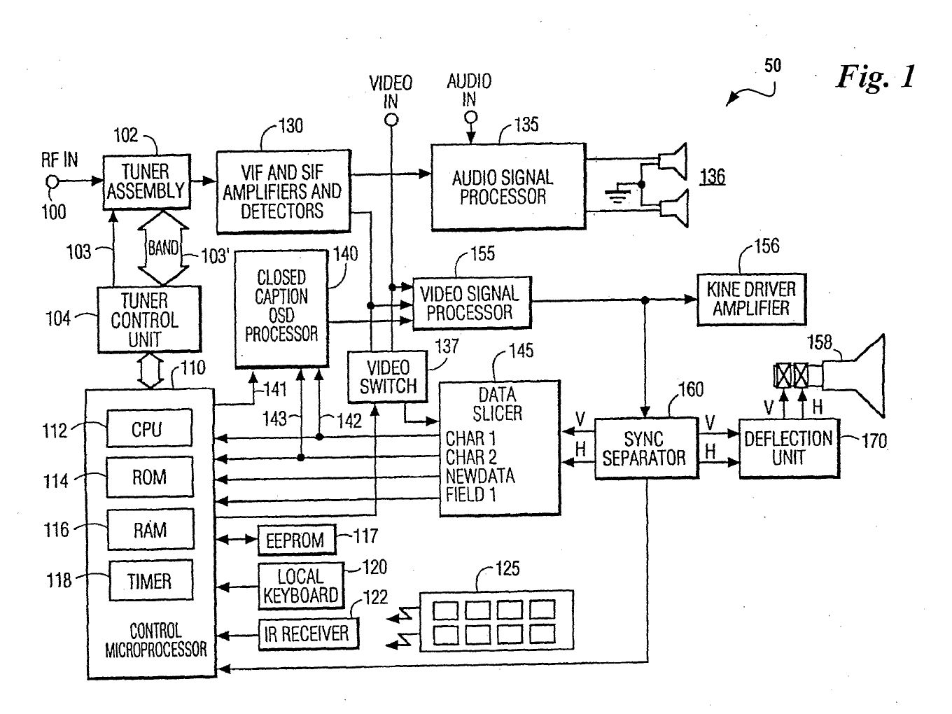

Referring to FIG. 1, there is shown a block diagram of a television receiver 50. U.S. Pat. No. 5,428,400, assigned to the assignee hereof, the entire disclosure of which is hereby incorporated by reference herein, discloses the configuration and operation of such a receiver. As shown in FIG. 1, television receiver 50 includes an RF input terminal 100, which receives radio frequency (RF) signals and applies them to a tuner assembly 102. Tuner assembly 102 selects and amplifies a particular RF signal under control of a tuner controller 104, which provides a tuning voltage via a wire 103, and band-switching signals via signal lines represented by the broad double-ended arrow 103′, to tuner assembly 102.

Tuner assembly 102 down-converts the received RF signal to an intermediate frequency (IF) signal, and provides the IF signal as an output to video (VIF) and sound (SIF) amplifier and detector unit 130. VIF/SIF amplifier and detector unit 130 amplifies the IF signal applied to its input terminal and detects the video and audio information contained therein. The detected video information is applied at one input of a video processor unit 155. The detected audio signal is applied to an audio processor 135 for processing and amplification before being applied to a speaker assembly 136.

Tuner controller 104 generates the tuning voltage and band-switching signals in response to control signals applied from a system controller, microcomputer or microprocessor 110. Controller 110 may take the form of an integrated circuit especially manufactured for that specific purpose (i.e., an application specific integrated circuit “ASIC”). Controller 110 receives user-initiated commands from an infrared (IR) receiver 122 and/or from a “local” keyboard 120 mounted on the television receiver itself. IR receiver 122 receives IR transmissions from remote control transmitter 125. Controller 110 includes a central processing unit (CPU) 112, a program or code memory (ROM) 114, and stores channel-related data in a random-access memory (RAM) 116. RAM 116 may be either internal to, or external to, microprocessor 110, and may be of either the volatile or non-volatile type. The term “RAM” is also intended to include electrically-erasable programmable read only memory (EEPROM) 117. One skilled in the art will recognize that if volatile memory is utilized, that it may be desirable to use a suitable form of standby power to preserve its contents when the receiver is turned off. Controller 110 also includes a timer 118.

Microcomputer (or controller) 110 generates a control signal for causing tuner control unit 104 to control tuner 102 to select a particular RF signal, in response to user-entered control signals from local keyboard 120 and/or infrared (IR) receiver 122.

As previously mentioned, tuner 102 produces a signal at an intermediate frequency (IF) and applies it to a processing unit 130 including a video IF (VIF) amplifying stage, an AFT circuit, a video detector and a sound IF (SIF) amplifying stage. Processing unit 130 produces a first baseband composite video signal (TV), and a sound carrier signal. The sound carrier signal is applied to audio signal processor unit 135, which includes an audio detector and may include a stereo decoder. Audio signal processor unit 135 produces a first baseband audio signal and applies it to a speaker unit 136. Second baseband composite video signals and second baseband audio signals may be applied to VIDEO IN and AUDIO IN terminals from an external source.

The first and second baseband video signals (TV) are coupled to video processor unit 155 (having a selection circuit not shown). Electrically-erasable programmable read only memory (EEPROM) 117 is coupled to controller 110, and serves as a non-volatile storage element for storing auto programming channel data, and user-entered channel data.

The processed video signal, at the output of video signal processor unit 155, is applied to a Kine Driver Amplifier 156 for amplification and then applied to the guns of a color picture tube assembly 158 for display. The processed video signal at the output of video signal processor unit 155, is also applied to a Sync Separator unit 160 for separation of horizontal and vertical drive signals which are in turn applied to a deflection unit 170. The output signals from deflection unit 170 are applied to deflection coils of picture tube assembly 158 for controlling the deflection of its electron beam.

A data slicer 145 receives closed caption data at a first input from VIF/SIF amplifier and detector unit 130, and at a second input from the VIDEO IN terminal via a video switch 137 that selects the proper source of closed-caption data under control of controller 110. Data slicer 145 supplies closed-caption data to closed caption processor 140 via lines 142 and 143. Data slicer 145 supplies closed-caption status data (NEWDATA, FIELD 1) to controller 110. Under control of controller 110, via control line 141, the closed caption processor 140 generates character signals, and applies them to an input of video signal processor 155, for inclusion in the processed video signal. Processor 140 and/or data slicer 145 may be included in controller 110. Although the embodiment of FIG. 1 is in the environment of a receiver having a cathode ray tube, it is clear that the principles of this invention are applicable to other types of receiver without a display, such as a set top box, which is able to receive, process, and provide closed caption data displays. Further, the invention is also applicable to receiver having different types of displays, such as, but not limited to, LCD, plasma, DLP, and LCOS.

As will be understood by those possessing an ordinary skill in the pertinent arts, the closed caption information may be received during the vertical blanking interval on television line 21 and/or as at least a portion of another data stream. Information related to closed caption services may also be provided using, for example, extended data services (XDS) transmitted in accordance with EIA/CEA 608B. In the digital television environment the closed caption data may be received in designated transport packets multiplexed with the video and audio packets. Multiplexing and de-multiplexing of video, audio, closed-captioning and/or other data is known in the pertinent arts, and described, for example, in U.S. Pat. No. 5,867,207, issued Feb. 2, 1999 to the assignee hereof, the entire disclosure of which is hereby incorporated by reference herein.

Modern televisions and receivers typically allow modification of caption size, font color, font background color, font text-style, background opacity and/or caption opacity. According to an aspect of the present invention, this capability may be leveraged to enhance conventional digital closed captioning services.

According to an aspect of the present invention, the appearance of digital closed caption content or text (e.g., E1A 708B complaint) is altered based on one or more predetermined conditions, such an associated program genre, keywords in the content itself, or program content speakers associated with corresponding portions of the digital closed caption content.

For example, closed captioning appearance parameters (e.g., size, font color, font background color, font text-style, background opacity and/or caption opacity) may be altered to reflect the “categorical genre code assignment” of a program. For example, a horror movie may have closed captioning content associated with it presented on a display device in red text on a black background, while closed captioning text associated with a cartoon is presented in multicolor text (per character, word or sentence, for example), using a cartoon font and a larger font size; and closed captioning content associated with a romance genre program is presented using a cursive font in pink or red.

More particularly, “genre” as used herein, generally refers to a topic, theme, category or type. Optionally, pre-configured genre dependent formatting may be provided. In addition, genre dependent formatting can be user altered or customized, such as by providing a conventional menu system to allow a user to enable or disable the genre-based caption feature globally, and/or match particular caption attributes (e.g., color, size, font text style) to particular genres, and/or individually enable or disable particular genre based formatting for particular genres. User interaction and/or selections may be facilitated through the use of keyboard 120 and/or remote control 125 in a conventional manner.

Genre information may be obtained either via a program stream (e.g., using the Program and System Information Protocol (PSIP) information from a digital TV signal) and/or Electronic Program Guide (EPG). The present invention will be further discussed as it relates to the use of PSIP information provided in an Advanced Television Systems Committee (ATSC) Digital Television (DTV) program stream for non-limiting purposes of explanation only. However, it should be understood, that the present invention has applicability to other systems as well.

The PSIP is well known in the pertinent arts, and is presented in the to Advanced Television Systems Committee (ATSC) Document A/65-B, entitled “Program and System Information Protocol for Terrestrial Broadcast and Cable”, dated Mar. 18, 2003, the entire disclosure of which is also hereby incorporated by reference herein. By way of non-limiting explanation, the PSIP is a collection of hierarchically-associated tables each of which describes particular elements of typical Digital Television (DTV) services. The base tables include: the System Time Table (STT), the Rating Region Table (RRT), the Master Guide Table (MGT), and the Virtual Channel Table (VCT). A Directed Channel Change Table (DCCT) and Directed Channel Change Selection Code Table (DCCSCT) may also be included. Event Information Tables (EITs) may also be included as part of the PSIP data structures.

The System Time Table (STT) carries time information for applications requiring synchronization. The Rating Region Table (RRT) defines rating tables valid for different regions or countries. The Master Guide Table (MGT) defines sizes, packet identifiers (PIDs) and version numbers for tables. The Virtual Channel Table (VCT) exists in two versions: one for terrestrial and a second for cable applications, and serves to tabulate virtual channel attributes required for navigation and tuning. The optional Directed Channel Change Table (DCCT) carries requests for a receiver to switch to specified virtual channels at specified times under specified circumstances. The optional Directed Channel Change Selection Code Table (DCCSCT) permits extension of the basic genre category and location code tables. Finally, each of the Event Information Tables (EITs) lists TV programs (events) for the virtual channels described in the VCT.

DCCTs are conventionally carried in MPEG-2 private sections with a table ID of 0xD3. Each DCCT provides definitions of virtual channel change requests. The requested channel change may be unconditional or based upon geographic, demographic or categorical broadcast programming content selection criteria. Several different DCCT instances may be present in a Transport Stream (TS) at any given time, each providing channel change information pertaining to one or more virtual channels. Contained within the DCCT is a “for loop” structure that provides for zero or more tests to be performed, to determine whether or not a channel change should be effected.

Each DCCT conventionally includes a dcc_selection_type field, which takes the form of an 8-bit unsigned integer specifying the type of the value contained in the dcc_selection_id. Dcc_selection_types of 0x07, 0x08, 0x017 and 0x018 correspond to tests for interests based upon one or more genre categories. Where a dcc_selection_type is equal to 0x07, 0x08, 0x017 or 0x018, the dcc_selection_id is a genre category selection code—which is indicative of a genre of the associated content. Genre category selection code bytes are placed right-justified in the 64-bit dcc_selection_id field, and take the form of a value in the range 0x01 through 0xFF. Exemplary genre category selection codes are illustrated in Table-1.

TABLE 1

| | |
|---|---|
| 0x00 | Not Available |
| 0x01-1F | Reserved |
| | (Basic) |
| 0x20 | Education |
| 0x21 | Entertainment |
| 0x22 | Movie |
| 0x23 | News |
| 0x24 | Religious |
| 0x25 | Sports |
| 0x26 | Other |
| 0x27 | Action |
| 0x28 | Advertisement |
| 0x29 | Animated |
| 0x2A | Anthology |
| 0x2B | Automobile |
| 0x2C | Awards |
| 0x2D | Baseball |
| 0x2E | Basketball |
| 0x2F | Bulletin |
| 0x30 | Business |
| 0x31 | Classical |
| 0x32 | College |
| 0x33 | Combat |
| 0x34 | Comedy |
| 0x35 | Commentary |
| 0x36 | Concert |
| 0x37 | Consumer |
| 0x38 | Contemporary |
| 0x39 | Crime |
| 0x3A | Dance |
| 0x3B | Documentary |
| 0x3C | Drama |
| 0x3D | Elementary |
| 0x3E | Erotica |
| 0x3F | Exercise |
| 0x40 | Fantasy |
| 0x41 | Farm |
| 0x42 | Fashion |
| 0x43 | Fiction |
| 0x44 | Food |
| 0x45 | Football |
| 0x46 | Foreign |
| 0x47 | Fund Raiser |
| 0x48 | Game/Quiz |
| 0x49 | Garden |
| 0x4A | Golf |
| 0x4B | Government |
| 0x4C | Health |
| 0x4D | High School |
| 0x4E | History |
| 0x4F | Hobby |
| 0x50 | Hockey |
| 0x51 | Home |
| 0x52 | Horror |
| 0x53 | Information |
| 0x54 | Instruction |
| 0x55 | International |
| 0x56 | Interview |
| 0x57 | Language |
| 0x58 | Legal |
| 0x59 | Live |
| 0x5A | Local |
| 0x5B | Math |
| 0x5C | Medical |
| 0x5D | Meeting |
| 0x5E | Military |
| 0x5F | Miniseries |
| 0x60 | Music |
| 0x61 | Mystery |
| 0x62 | National |
| 0x63 | Nature |
| 0x64 | Police |
| 0x65 | Politics |
| 0x66 | Premier |
| 0x67 | Prerecorded |
| 0x68 | Product |
| 0x69 | Professional |
| 0x6A | Public |
| 0x6B | Racing |
| 0x6C | Reading |
| 0x6D | Repair |
| 0x6E | Repeat |
| 0x6F | Review |
| 0x70 | Romance |
| 0x71 | Science |
| 0x72 | Series |
| 0x73 | Service |
| 0x74 | Shopping |
| 0x75 | Soap Opera |
| 0x76 | Special |
| 0x77 | Suspense |
| 0x78 | Talk |
| 0x79 | Technical |
| 0x7A | Tennis |
| 0x7B | Travel |
| 0x7C | Variety |
| 0x7D | Video |
| 0x7E | Weather |
| 0x7F | Western |
| 0x80 | Art |
| 0x81 | Auto Racing |
| 0x82 | Aviation |
| 0x83 | Biography |
| 0x84 | Boating |
| 0x85 | Bowling |
| 0x86 | Boxing |
| 0x87 | Cartoon |
| 0x88 | Children |
| 0x89 | Classic Film |
| 0x8A | Community |
| 0x8B | Computers |
| 0x8C | Country Music |
| 0x8D | Court |
| 0x8E | Extreme Sports |
| 0x8F | Family |
| 0x90 | Financial |
| 0x91 | Gymnastics |
| 0x92 | Headlines |
| 0x93 | Horse Racing |
| 0x94 | Hunting/Fishing/ |
| | Outdoors |
| 0x95 | Independent |
| 0x96 | Jazz |
| 0x97 | Magazine |
| 0x98 | Motorcycle |
| | Racing |
| 0x99 | Music/Film/Books |
| 0x9A | News- |
| | International |
| 0x9B | News-Local |
| 0x9C | News-National |
| 0x9D | News-Regional |
| 0x9E | Olympics |
| 0x9F | Original |
| 0xA0 | Performing Arts |
| 0xA1 | Pets/Animals |
| 0xA2 | Pop |
| 0xA3 | Rock & Roll |
| 0xA4 | Sci-Fi |
| 0xA5 | Self |
| | Improvement |
| 0xA6 | Sitcom |
| 0xA7 | Skating |
| 0xA8 | Skiing |
| 0xA9 | Soccer |
| 0xAA | Track/Field |
| 0xAB | True |
| 0xAC | Volleyball |
| 0xAD | Wrestling |
| 0xAE- | Reserved |
| FE | (Detailed) |
| 0xFF | Null (not a |
| | category) |

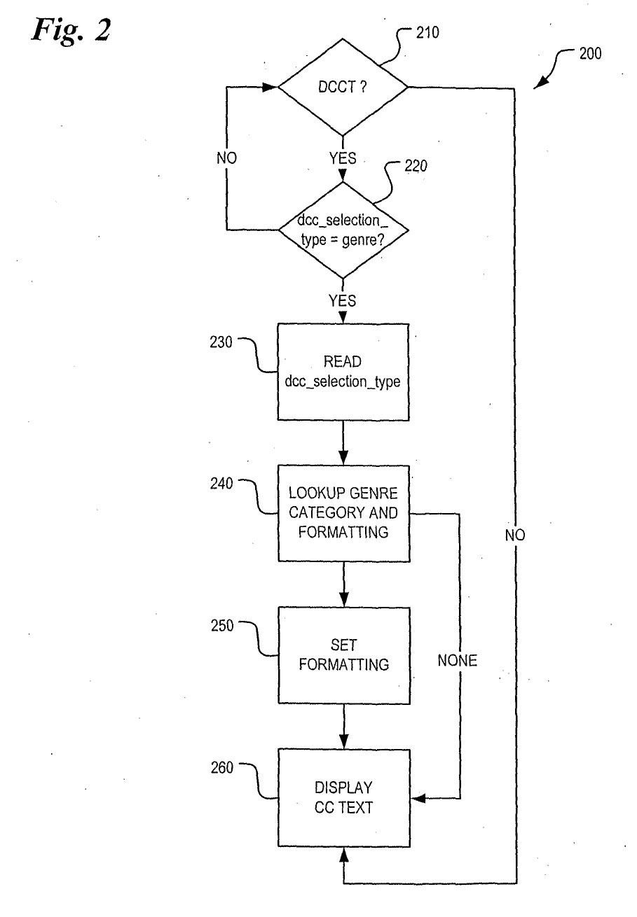

According to an aspect of the present invention, the genre codes present in dcc_selection_id fields may be used to selectively customize closed captioning content. Referring now to FIG. 2 in addition to FIG. 1, there is shown a process flow 200 according to an aspect of the present invention. Process 200 is suitable for introducing genre dependent formatting for closed captioning content. Process 200 may be embodied in a plurality of CPU 112 executable instructions (e.g., a program) being stored in memory 114, 116, 117. Process flow 200 begins with determining whether a DCCT is included in a PSIP corresponding to programming of interest (step 210): If no DCCT is present, closed captioning content may be processed in a conventional manner (e.g., displayed in step 260). If a DCCT is detected, it is then determined (step 220) whether a dcc_selection_type is indicative of a genre indication in the dcc_type_selection_id, (e.g., the dcc_selection_type is equal to 0x07, 0x08, 0x017 or 0x018). If it is not, step 210 may be repeated to determine whether another DCCT is available, as more than one DCCT may be present in a Transport Stream (TS). Where a dcc_selection_type indicative of a genre is detected (step 220), the dcc_selection_id may be then captured or read, e.g., recorded to memory 116 (step 230). The recorded value, or dcc_selection_type information, is then correlated to an associated formatting (step 240). This correlation can be effected using a look-up table or database, for example. The lookup table may include information such as that included in Table 1. Additionally, the look-up table may include formatting information, such as data indicative of the values depicted in Table 2. Of course, Tables 1 and 2 could also be combined.

TABLE 2

| | | | | FONT | FONT | | |
|---|---|---|---|---|---|---|---|
| | | | FONT | BACKGROUND | TEXT- | BACKGROUND | CAPTION |
| CODE | SIZE | FONT | COLOR | COLOR | STYLE | OPACITY | OPACITY |
| 0x52 | NORMAL | NORMAL | RED | BLACK | NORMAL | NORMAL | NORMAL |
| 0X70 | NORMAL | CURSIVE | PINK | WHITE | NORMAL | NORMAL | NORMAL |
| 0X87 | LARGE | CARTOON | VARIES | NORMAL | NORMAL | NORMAL | NORMAL |

Thereafter, the recovered formatting preference (if any) (step 240) may be selected to be applied to the closed caption content (step 250). The closed caption content may be processed in a conventional manner to determine the text information, and display processing applied using the formatting preferences set by step 250, if any, and displayed (step 260). For example, upon detecting a romance genre indicative dcc_selection_id 0x70 (see Table-1), closed caption content may be presented using a pink cursive font on a white background (see Table-2). Data indicative of the information stored in Table-2 may be modified by a user, via conventional menu driven processes, for example.

Where more than one genre code is presented for a program, different formats may be called for different combinations, and/or a most specific coding applicable to the program may optionally be selected. For example, boxing genre dependent formatting is used when both 0x86 (boxing) and 0x25 (sports) dcc_selection_id codes are present.

Although described above in terms of PSIP, the present invention may use alternative mechanisms for determining genre information. For example, the genre information may be extracted from an EPG, or from XDS data, and used in analogous fashion.

Alternatively, or in addition to genre dependent formatting, the entertainment value and comprehension of digital closed captions may be enhanced by changing the appearance of particular words relative to other words using the caption attributes (e.g., size, font color, font background color, font text-style, background opacity, caption opacity). In other words, digital closed caption content may be formatted based upon the content itself.

In one embodiment certain keywords may be selected based on their significance in the genre. For example, in a boxing program, keywords related to the action, such as KNOCKOUT, UPPERCUT, HOOK, etc, may be highlighted using different attributes than the words related to the background commentary. Also, certain keywords may be selected based on their general significance. For example, words that may be deemed obscene may be formatted to be larger than surrounding text and/or in a different color (e.g., red), and/or use the “ALL CAPS” font instead of a mixed-upper-and-lower-case font. In addition, or in lieu of such an approach, the appearance of words may suggest their meaning. For example, “cold” may be formatted in blue text, “hot” in red text, “grass” in green text, “angry” in red text, and/or “jealous” in green text. Additionally, or in lieu thereof, interjections (e.g., “Hey!”, “Stop!”, “Ouch!”) may be presented in a larger font than surrounding text. Additionally, or in lieu thereof, “Help!” may be presented using a “flashing” attribute of the caption opacity and/or background opacity. Of course numerous implementations exist.

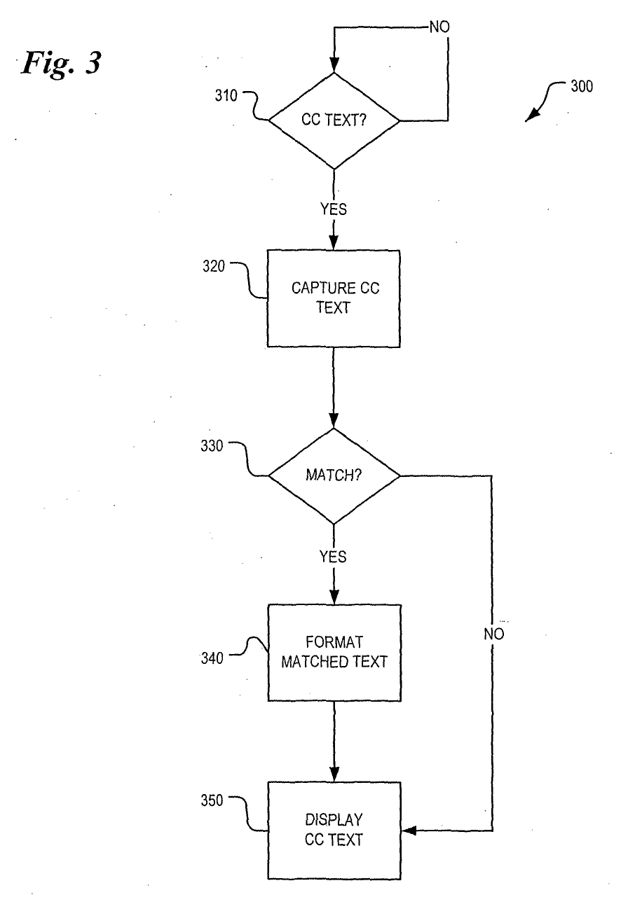

Referring now to FIG. 3 in conjunction with FIG. 1, there is shown a process flow 300 suitable for formatting digital closed caption content depending upon the closed captioning content itself. Process 300, like process 200, may be embodied in one or more CPU 112 executable instructions (e.g., a program) being stored in memory 114, 116, 117. Process flow 300 begins with determining whether there is unprocessed digital closed caption content available (step 310). When there is, the digital closed caption content is captured (step 320). The captured text is compared to known patterns to be specially formatted (step 330). This may be accomplished using a lookup table or database, for example. The lookup table may include data indicative of information akin to that included in Table 3.

TABLE 3

| | | | | FONT | FONT | | |
|---|---|---|---|---|---|---|---|
| | | | FONT | BACKGROUND | TEXT- | BACKGROUND | CAPTION |
| TEXT | SIZE | FONT | COLOR | COLOR | STYLE | OPACITY | OPACITY |
| DARN | NORMAL | CAPS | RED | NORMAL | NORMAL | NORMAL | NORMAL |
| COLD | NORMAL | NORMAL | BLUE | NORMAL | NORMAL | NORMAL | NORMAL |
| HOT | NORMAL | NORMAL | RED | NORMAL | NORMAL | NORMAL | NORMAL |
| ANGRY | NORMAL | NORMAL | RED | NORMAL | NORMAL | NORMAL | NORMAL |
| JEALOUS | NORMAL | NORMAL | GREEN | NORMAL | NORMAL | NORMAL | NORMAL |
| HEY | LARGE | NORMAL | NORMAL | NORMAL | NORMAL | NORMAL | NORMAL |
| STOP | LARGE | NORMAL | NORMAL | NORMAL | NORMAL | NORMAL | NORMAL |
| OUCH | LARGE | NORMAL | NORMAL | NORMAL | NORMAL | NORMAL | NORMAL |
| HELP | NORMAL | NORMAL | NORMAL | NORMAL | NORMAL | FLASH | FLASH |

If no match is found (step 330), conventional closed caption processing may be used (step 350). If a match is found, the select text may be formatted using the associated special formatting (step 340) (e.g., different color, size, opacity, font, for example). The modified closed caption text may then be processed conventionally (step 350) using the specialized formatting as a user defined formatting for the associated text.

In addition, or in lieu of formatting all or part of the digital closed caption content based upon the associated program genre and/or content itself, analogous formatting may be based upon an associated speaker's identity. For example, in digital closed caption content indicative of programming including a conversation between first and second speakers, content or text associated with the first speaker may have one or more associated caption attributes (e.g., size, font color, font background color, font text-style, background opacity and/or caption opacity) associated with the first speaker, while content or text associated with the second speaker may have one or more associated caption attributes (e.g., size, font color, font background color, font text-style, background opacity and/or caption opacity) associated with the second speaker. For example, content or text associated with the first speaker may be presented in blue, while content or text associated with the second speaker is presented in yellow.

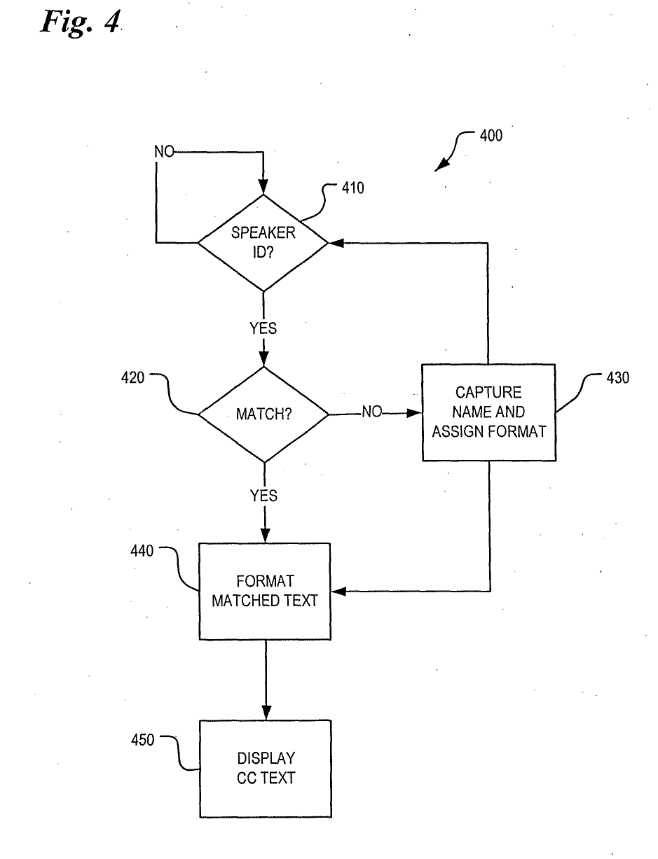

Referring now also to FIG. 4, there is shown a block diagram of a process 400 suitable for formatting digital closed captioning content dependently upon an identified speaker. Process 400 may be embodied in one or more CPU 112 executable instructions (e.g., a program) being stored in memory 114, 116, 117. By way of further, non-limiting example only, digital caption text complying with the EIA-708B standard may be tagged with a marker indicating the type of text content that is encoded. One of these markers is “source or speaker ID”, which is indicative of the speaker, or a description of the source of a sound. According to an aspect of the present invention, when source or speaker ID″ is detected (step 510), the indicated speaker name may be compared to speaker names stored in memory, e.g., memory 116, (step 520). If a match is not found (step 520), the speaker's name may be stored and a font style assigned to it, e.g., “Sally”=Bold_Underline (step 530). Thereafter, the closed caption content or text associated with the stored speaker name (e.g., appearing in the same line) is formatted according to the stored style (step 540) and displayed (step 550). The next time that a source or speaker ID tag is detected (step 510), the decoder again checks if the speaker name is the same or different than a previously-saved speaker name (step 520). If it's a different speaker, then that unique speaker name gets its own unique font style, e.g., “Bob”=Italics_Red, and so on. Where a match is found (step 520), the associated style is used (steps 540, 550). When the programming ends, or a channel is changed for example, the decoder erases the saved speaker names and their matched font styles so that another program can start sampling for the next unique set of speaker names.

According to an aspect of the present invention, a user-set custom font style for each of a number of speakers may be pre-defined and/or user defined (e.g., using keyboard 120 and/or remote control 125). In such a case, the definitions may take the form of: first speaker name stored=green text on yellow background, italics, no underline; second speaker name stored=yellow text on green background, no italics, underline, and so on, by way of non-limiting example only. According to an aspect of the present invention, matching step 520 may take the form of accessing a simple look-up table or a database, akin to Table 3, wherein the text entry is indicative of a detected speaker's name.

Additionally, according to an aspect of the present invention, condition dependent formatting may be augmented by converting predetermined text strings into graphical representations. For example, non-speech information (NSI) text strings, and/or curse words, may be converted into icons for display. NSI is a term to describe aspects of the sound track, other than spoken words, that convey information about plot, humor, mood, or meaning of a spoken passage, e.g., “laughter” and “applause”. “Icon”, as used herein, generally refers to a small picture or character. According to another embodiment, the user may be provided with an interface, using a set up menu or the like, to selectively enable or disable the automatic identifying and formatting of the portions of closed caption display described above.

The graphical content may be introduced by replacing select caption text (such as text that is repetitively used) with icons (which may optionally be animated). For example, commonly used words may be replaced with associated icons indicative of the replaced words. For example, “laughter” may be replaced by an icon of a face laughing, while “applause” may be replaced by an icon of two hands clapping. By way of further non-limiting example, when the word “whispering” is detected in the captions, an icon associated with and indicative of whispering (e.g., profile of person's head with hand put to side of mouth) may be displayed instead of the word. Further, when objectionable digital closed captioning content is detected, it may be redacted by inserting an icon, or an icon/text combination that is less objectionable. In effect, a caption “short-hand” may be presented to viewers.

When a keyword is detected in digital closed caption content, the text may be replaced with an icon stored in memory. This inserted graphic may take the form of a “character” in the closed captioning font that looks like an icon (much like how the Wingdings font is really just a font where all characters are icons).

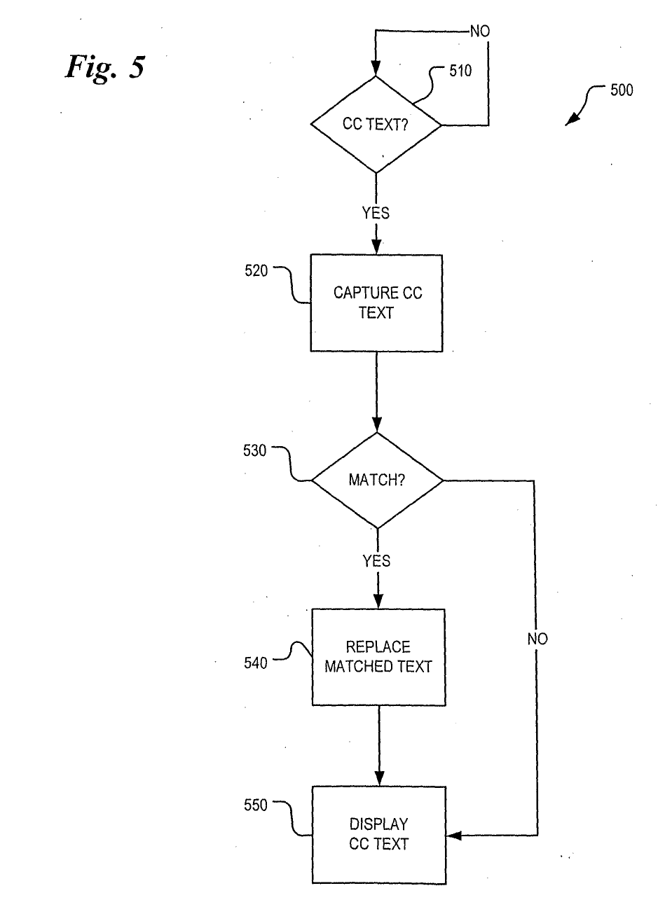

Referring now to FIG. 5 in addition to FIG. 1, there is shown a process flow 500 according to an aspect of the present invention. Process 500 is suitable for introducing graphical representations of digital closed caption text into the closed captioning content. Process 500, may be embodied in a plurality of CPU 112 executable instructions (e.g., a program) being stored in memory 114, 116, 117. Process flow 500 begins with determining whether there is unprocessed closed caption text available (step 510). When there is, the closed caption text is captured (step 520). The captured text is compared to known patterns to be replaced (step 530). This may be accomplished using a lookup table or a database for example. The lookup table may include data indicative of information akin to that shown in Table 4.

TABLE 4

| Text | Replacement |
|---|---|
| Laughter | Smiling face icon |
| Applause | hands clapping |
| | icon |

If no match is found (step 530), conventional closed caption processing may be used (step 550). If a match is found (step 530), the matching text may be replaced with the replacement character or icon (step 540). The modified closed caption text may then be processed conventionally (step 550).

It will be apparent to those skilled in the art that modifications and variations may be made in the apparatus and process of the present invention without departing from the spirit or scope of the invention. It is intended that the present invention cover the modification and variations of this invention provided they come within the scope of the appended claims and their equivalents.

1. A method for processing closed caption information associated with a video program, comprising:
identifying a parameter associated with the video program; and,
formatting the appearance of the closed caption information in response to the parameter.

2. The method of claim 1, wherein the parameter comprises genre information associated with the video program.

3. The method of claim 2, wherein said identifying comprises extracting genre information from an associated program and system information protocol signal.

4. The method of claim 2, wherein said identifying comprises extracting genre information from extended data services information transmitted with the video program.

5. The method of claim 2, wherein said identifying comprises extracting genre information from an electronic program guide.

6. The method of claim 2, wherein said formatting comprises changing at least one parameter selected from the group consisting of: size, font, font color, font back-ground color, font text-style, background opacity and caption opacity.

7. The method of claim 1, further comprising identifying the presence of a keyword in the closed caption information and formatting the keyword in a manner distinguishable from other portions of the closed caption information.

8. The method of claim 7, wherein the distinguishable manner comprises at least one difference in size, font, font color, font back-ground color, font text-style, back-ground opacity or caption opacity.

9. The method of claim 7, wherein the keyword is indicative of non-speech information.

10. The method of claim 1, further comprising identifying particular caption information associated with a particular speaker and formatting the particular caption information with other portions of the closed caption information.

11. An apparatus comprising:
a memory storing data indicative of a plurality of formats each corresponding to an associated condition;
a receiver for receiving a video program and associated closed caption content;
a detector for detecting a parameter associated with the video program; and
a processor for formatting the appearance of a portion of the received closed caption content in response to the detection of the parameter.

12. The apparatus of claim 11, wherein the parameter comprises genre information associated with the video program.

13. The apparatus of claim 11, wherein the detector detects genre information from an associated program and system information protocol signal.

14. The apparatus of claim 11, wherein the detector detects genre information from extended data services information transmitted with the video program.

15. The apparatus of claim 11, wherein the detector detects genre information from an electronic program guide.

16. The apparatus of claim 11, wherein the processor changes at least one parameter selected from the group consisting of: size, font, font color, font back-ground color, font text-style, back-ground opacity and caption opacity.

17. The apparatus of claim 11, wherein the parameter comprises the presence of a keyword, and the processor formats the appearance of the keyword in a manner distinguishable from other portion of the closed caption content.

18. The apparatus of claim 17, wherein the keyword is indicative of non-speech information.

19. The apparatus of claim 17, wherein the detector detects a particular speaker associated with selected portions of the closed caption content, and the processor formats the selected portions in a manner distinguishable from other portions of the closed caption content.
